(19) United States
(12) Patent Application Publication
(10) Pub. No.: US 2020/0103074 A1
(43) Pub. Date: Apr. 2, 2020

(54) A TRANSPORTABLE SYSTEM FOR DELIVERING LUBRICANT TO A LUBRICATION TARGET AND PARTS THEREFOR

(71) Applicant: Hove A/S, Glostrup (DK)

(72) Inventors: William Lisby, Svendborg (DK); Thomas Lisby, Svendborg (DK)

(21) Appl. No.: 16/497,894

(22) PCT Filed: Apr. 4, 2018
(86) PCT No.: PCT/EP2018/058549

§ 371 Date: Sep. 26, 2019

(30) Foreign Application Priority Data
Apr. 5, 2017 (EP) EP17165033.6

(51) Int. Cl. F16N 21/00; F16N 37/00; F16N 13/20; F16N 7/38; F01M 1/02; F01M 11/04; F01M 11/10; F04C 29/02; F16K 17/04

(52) U.S. Cl. CPC F16N 21/00; F16N 37/00; F16N 13/20; F16N 7/38; F01M 1/02; F01M 2001/0238; F01M 11/10; F04C 29/025; F16K 17/0473; F16N 2280/00; F16N 2037/006; F01M 11/0458

(57) ABSTRACT

The present invention relates to a transportable system for delivering lubricant to a target, more specifically for lubricating machine parts and/or for re-filling a central or a de-central lubricating system. Further, the present invention relates to parts of the transportable system, the parts being a pressure releasing coupling, a gear pump and/or a high pressure pump.

### REFERENCE TO RELATED APPLICATIONS

This is a U.S. national stage patent application No. PCT/EP2018/058549, filed Apr. 4, 2018, which claims priority to European Patent Application No. EP 17165033.6, filed Apr. 5, 2017. The entire content of each application is incorporated herein by reference.

### FIELD OF THE INVENTION

The present disclosure relates to a transportable system for delivering lubricant to a target, more specifically for lubricating machine parts and/or for re-filling a central or a de-central lubricating system. Further, the present disclosure relates to parts of the transportable system, the parts being a pressure releasing coupling, a gear pump and/or a high pressure pump.

### BACKGROUND OF THE INVENTION

Lubrication of machine parts is known in the wind turbine industry. Current solutions for lubrication involve manual application of grease and carrying around a rather heavy lubrication station. Manual application of grease can be done in cases when there is no need for delivering a high pressure and/or if physical work is not an issue. In most cases, there is however a demand for providing an easy application of lubricant to a target because hard work is considered an issue. In many cases, there is also a requirement for getting the lubricant delivered to the target, and since lubricant is a very dense material, a pump is typically required. When handling lubricant, materials for delivering the lubricant need to be robust and made for harsh environments. As a consequence, the mobile solutions for delivering lubricant to a lubrication target, which currently exist, are heavy because the materials and parts for such solutions are solid and large. Hence, current mobile solution for lubrication systems that are made with pumps, are not that mobile in the sense that they are not easy to carry around. There is thus a desire for a light-weight lubrication station and parts for such that is able to pump very dense lubrication to a lubrication target while at the same time being adapted to harsh industrial environments.

Further, when connecting mobile lubrication stations for delivering lubricant to machine parts or to containers holding lubricant, for example to re-fill the containers, typically at least a hose needs to be changed from place to place. Such work typically requires tools, and in case the mobile lubrication station is equipped with a high pressure pump, it may be very difficult to change the hose, in particular because the pressure inside the mobile lubrication station and the hoses are very high. A great amount of force on the tool is therefore typically required to connect or disconnect a hose. Further, since high pressure may exist within the lubrication station and the hoses, a disconnection of a hose, may in worst case scenario result in the lubricant inside the lubrication station is expelled out of the lubrication station and hits the operator at high speed. This can cause severe injuries. Hence, present solutions for connection or disconnections of hoses in systems with lubricant are non-safe. There is thus a need for safe lubrication systems and a part for such that provides this solution.

Finally, when delivering lubricant, for example very dense grease, to machine parts that are far removed from the lubrication station, a high pressure pump is required. A typical high pressure pump typically provides a high pressure of around 10-20 bars. Such pumps may be suitable for lubrication a small amount of grease to a machine part. However, when delivering lubricant, for example also grease with high viscosity, to a relatively large container, such as around 5 liters or more, for example to re-fill it, a typical high pressure pump may do the job, however the re-fill time may be relatively long. There is thus a need for an effective lubrication system.

### SUMMARY OF THE INVENTION

It is an objective of the present disclosure to solve the above described problems and fulfil the required needs. The present disclosure solves the above described problems by providing the following aspects of the disclosure.

The present disclosure relates in a first aspect to a pressure releasing coupling, comprising: a housing comprising an internal channel inside the housing; a first inlet for a receiving a lubricant; a first outlet and a second outlet, each outlet for guiding the lubricant, wherein the first inlet, the first outlet and the second outlet are in fluid communication with the internal channel; and a pressure releasing element configured to slide between a first position and a second position inside the internal channel, and configured such that: in the first position, the lubricant is guided from the first inlet to the first outlet, and in the second position, the lubricant is guided from the first outlet to the second outlet for releasing a pressure in the first outlet.

The present disclosure relates in a second aspect to a transportable system for delivering lubricant to a lubrication target, comprising: a pump connected to the pressure releasing coupling according to the first aspect.

The pressure releasing coupling according to the first aspect and the transportable system is able to be connected and/or disconnected with hoses between a pump and a lubrication target in an easy and safe manner, because the pressure releasing element is able to release the pressure without using a tool. All in all, integrating a pressure releasing coupling according to the present disclosure in a transportable lubrication system provides a safe and easy-operated transportable lubrication system.

The present disclosure relates in a third aspect to a transportable system for delivering lubricant to a lubrication target, comprising a gear pump. A gear pump for liquids in general, may in its simplest form comprise a pump chamber configured for holding a liquid; an inlet in the pump chamber for providing the liquid to the pump; an outlet in the pump chamber for dispensing the liquid; and a driving gear wheel meshing with a driven gear wheel inside the pump chamber. Thus, a gear pump is much simpler than for example a piston pump. It is therefore also much lighter. The inventors of the present disclosure have found that using a gear pump in a transportable system for delivering lubricant to a lubrication target provides a light weight system, which is therefore much easier to transport than a system with for example a membrane pump. In addition, the inventors have found that the gear pump is also much better in handling particles as present in harsh industrial environments, such as dust and dirt, and can therefore last longer than typical lubrication systems used in such environments. Even further, the inventors have found that the motor driving the gear pump may be lighter than a motor used in typical lubrication systems, for example driving a membrane pump. Finally, the inventors have found that a gear pump and/or the motor therefor can be made very compact. All in all, integrating a gear pump in a transportable lubrication system provides a light weight, compact and low-maintenance transportable lubrication system. The transportable system according to the third aspect preferably delivers lubricant at a flow rate of between 45 g per minute and 450 g per minute. Such a flow rate may be typical for lubricating parts, such as machine parts. The lubricant for the transportable system according to the third aspect may be also be defined according to the standard referred to as ISO 2137[ 1/10 mm], and according to that standard, a lubricant between 150 and 450.

The present disclosure relates in a fourth aspect to a transportable system for delivering lubricant to a lubrication target, comprising a pump configured for delivering lubricant at a flow rate of more than 1 kg per minute. In most embodiments, the pump is configured for providing a flow rate of more than 1.5 kg per minute such as more than 1.8 kg per minute, such as more than 2 kg per minute, or such as more than 2.2 kg per minute. In most embodiments, the lubricant as herein referred to is a lubricant with a density less than 920 kg/m³ (specified at 20 degrees C.), most preferably around 910 kg/m³ (specified at 20 degrees C.). Moreover, the lubricant as herein referred to is in most embodiments a lubricant with a high viscosity, meaning a kinematic viscosity of more than 10 mm²/s at 40° C. When measured at 40° C., there is basis for the ISO viscosity grading system (ISO 3448). Accordingly, the lubricant may be a lubricant with a viscosity class or grade (VG) of more than VG 10 as defined by the ISO 3448 standard. In comparison, water has a viscosity of 0.6579 mm²/s at 40° C. The lubricant as referred to herein may thus be more than 15 times viscous than water. Specific lubricants may be with more than or around VG 15 such as more than or around VG 20, such as more than or around VG 32, such as more than or around VG 68. Such lubricant may be large industrial motors. In other embodiments the lubricant as referred to herein may be of more than or around VG 100, such as more than or around 200 VG, such as more than or around VG 320, such as more than or around VG 500, such as more than or around VG 1000, such as more than or around VG 1500, such as more than or around VG 2000. Hence, the lubrication system as disclosed herein is made for industrial purposes where the lubricant is highly viscous as specified above.

Further, the lubricant as herein referred to is in preferred embodiments a lubricant a defined according to DIN 51818, and measured by the measuring standards ASTM D217 or ASTM 4301. Accordingly, the lubricant as herein referred to is in preferred embodiments, a lubricant with a value specified by the National Lubrication Grease Institute, called the NLGI. The lubricant as referred to herein may therefore be an NLGI value between 00 and 4, and/or an NLGI value greater than 00, and/or an NLGI value greater than 1, and/or an NLGI value greater than 2, and/or an NLGI value greater than 3, such as around NLGI 4. In some embodiments, the lubricant may be with an NLGI value greater than 4.

The flow rate may be defined by a corresponding pressure output from the pump. Accordingly, the pump may be configured for providing a pressure of lubricant by more than 50 bars, such as more than 100 bars, such as more than 150 bars, such as more than 200 bars. All in all, integrating a high-pressure pump as here defined in a transportable lubrication system provides an efficient transportable lubrication system, in particular thereby configured for re-filling lubricant to a container.

The last three aspects related to a transportable system may either be individual systems, or combined in any manners to provide a single system which has all the advantages of each of the three systems.

The present disclosure relates in a fifth aspect to the use of the transportable system according to the second, third and fourth aspect for lubricating machine parts, such as in a wind turbine.

The present disclosure relates in a sixth aspect to the use of the transportable system according to the second, third and fourth aspect for re-filling lubricant in a central lubrication system, such as used in a single wind turbine.

The disclosure relates in a seventh aspect to the use of the transportable system according to the second, third and fourth aspect for re-filling lubricant in a de-central lubrication system, such as used in a wind turbine park.

### BRIEF DESCRIPTION OF THE DRAWINGS

FIG. 1 is a cross-section of an embodiment of the pressure releasing coupling according to the present disclosure in the first position;

FIG. 2 is a cross-section of an embodiment of the pressure releasing coupling according to the present disclosure in the second position; and

FIG. 3 is an exploded view of an embodiment of the internal channel in the pressure releasing coupling.

### DETAILED DESCRIPTION OF THE INVENTION

### Pressure Releasing Coupling—Pressure Releasing Element

In one embodiment of the pressure releasing coupling, at least a part of the pressure releasing element comprises a hollow section such that the lubricant is guided within at least part of the hollow section and inside the pressure releasing element. This embodiment provides for a compact solution for the pressure releasing coupling.

In a second embodiment of the pressure releasing coupling, the hollow section is open-ended in one end of the pressure releasing element, such that the first outlet is formed by the pressure releasing element. This embodiment provides for a compact solution for the pressure releasing coupling in that the first outlet needs to be formed from the internal channel.

In a preferred embodiment of the pressure releasing coupling, the pressure releasing element comprises at least two side holes such that the pressure releasing element is configured for guiding the lubricant into the hollow section via at least a first side hole and out of the hollow section to the second outlet via at least a second side hole.

In a most preferred embodiment of the pressure releasing coupling, the pressure releasing element comprises more than two side holes, such as more than four side holes, such as more than six holes, such as eight holes, such that the pressure releasing element is configured for guiding the lubricant into the hollow section via at least two first side holes, such as via at least three first side holes, such as via four first side holes, and out of the hollow section to the second outlet via at least two second side holes, such as via at least three second side holes, such as via four second side holes. When eight holes, there are preferably a set of four holes, a first set for the inlet and a second set for the outlet. The set of four holes are most preferably distributed on the side of the pressure releasing element, such that each of the four holes is separated from another by 90 degrees. In this way, lubricant is distributed into and out of the pressure releasing element from four directions, thereby providing an optimal flow.

When having at least two side holes, the at least two first side holes are each dimensioned with a hole diameter being less than the diameter of the inlet, and such that a pressure in the inlet is identical to the pressure in the hollow section. In other words, the dimensions of the side holes are matched to the dimension of the inlet, such that pressure differences are avoided. Thereby a loss of pressure is prevented. Furthermore, by having holes that are smaller than the hole of the inlet, there is provided a compact solution for a pressure releasing coupling.

In many embodiments of the pressure releasing coupling, the pressure releasing element comprises the first outlet, such that movement of pressure releasing element from the first position to the second position moves the first outlet relative to the first inlet and the second outlet. This embodiment provides for an easy and compact solution, where the pressure can be released by moving the first outlet. The first outlet is in most cases coupled to a lubricant target, for example via a hose. If the hose needs to be disconnected from the first outlet, and replaced with another hose, for example at another place, the user simply presses the outlet, whereby the pressure is released, and disconnects the hose without a pressure in the coupling and the hose. Accordingly, this embodiment provides for an easy and fast operated coupling. In particular, the present disclosure provides a quick disconnect/connect coupling.

In most embodiments, the pressure releasing element is elongated. The pressure releasing element may extent out of the top of the housing. The pressure releasing element may be considered as a rod, in particular a piston rod.

To provide a compact solution for a pressure releasing coupling, the first outlet forms a male connector, in particular when the first outlet is in the pressure releasing element and in form of a rod.

### Pressure Releasing Coupling—Inlet, Outlets and Housing

In one embodiment of the pressure releasing coupling, the first inlet and the second outlet are formed in the housing. Most preferably the first inlet and the second outlet are on the side of the housing. One the side of the housing, space may not be an issue. Accordingly, the first inlet and/or the second outlet form(s) may be female connector(s).

In a preferred embodiment of the pressure releasing coupling, the housing further comprises a push-back element configured such that when in the second position, the pressure releasing element is in contact with the push-back element, whereby the pressure releasing element is forced back to the first position. This embodiment provides for a quick connect/disconnect coupling where pressure is released, for example by a user pressing on the pressure releasing element, whereby the pressure releasing element returns to its first position. When the pressure is released by the pressure releasing element, lubricant is guided out of the coupling, such that the lubricant is not guided towards the target. This may be a spill, and the push-back element may therefore reduce this spill.

In a most preferred embodiment of the pressure releasing coupling, the push-back element is a spring. Most preferably, the push-back element may be located at the bottom of the housing, i.e. in the bottom of the internal channel.

In most embodiments, the first inlet is parallel to the second outlet and the first outlet is perpendicular to the first inlet. The second outlet may be located below the first inlet, and on the side of the housing. In these embodiments, gravity also helps to release the pressure.

In some embodiments of the pressure releasing coupling, the housing further comprises a flush outlet for guiding lubricant that is not guided out of the first and/or the second outlet. For example, if the internal channel is not sealed properly when the pressure releasing element is sliding therein, lubricant may be guided towards the bottom of the internal channel. Accordingly, the flush outlet may be located at the bottom of the housing, i.e. at the bottom of the internal channel.

### Pressure Releasing Coupling—Internal Channel

In one embodiment of the pressure releasing coupling, the internal channel further comprises a first inner surface that separates the internal channel into a first inner channel and a first outer channel, wherein the first inner channel is adapted for tightly fitting around at least a first part of the pressure releasing element, and wherein the first outer channel is adapted for guiding the lubricant from the first inlet into the pressure releasing element via a first plurality of holes in the first inner surface and further to the first outlet.

In a second embodiment of the pressure releasing coupling, the internal channel further comprises a second inner surface that separates the internal channel into a second inner channel and a second outer channel, wherein the second inner channel is adapted for tightly fitting around at least a second part of the pressure releasing element, and wherein the second outer channel is adapted for guiding the lubricant out of the pressure releasing element via a second plurality of holes in the second inner surface and further to the second outlet.

In a third embodiment of the pressure releasing coupling, the internal channel further comprises a third inner surface that narrows the internal channel into a third inner channel, wherein the third inner channel is adapted for tightly fitting around at least a third part of the pressure releasing element, and adapted for blocking the lubricant from the pressure releasing element.

According to the three above embodiments, the three inner channels may divide the internal channel into layers wherein each of these layers are lubricant tight, such that a pressure in one layer may be different from another or a third layer. The layers or inner and/or outer channels may be provided in several ways.

In one embodiment, the internal channel further comprises a plurality of lubricant blocking surfaces such that the lubricant is further prevented from being guided between the first outer channel and the second outer channel.

On another embodiment, the internal channel further comprises a plurality of sealing means such that the lubricant is further prevented from being guided between the first outer channel and the second outer channel.

In a first preferred embodiment, the first inner channel and the second inner channel are formed by a first annular element and a second annular element placed in the internal channel, each annular element comprising a cylindrical body with a plurality of holes, and wherein the first outer channel and the second outer channel each is formed by two flanges extending radially from the cylindrical element.

In a second preferred embodiment, the third inner channel is formed by a third annular element placed in the internal channel between the first and the second annular element, the third annular element comprising a cylindrical body.

In accordance with the above, the lubricant blocking surfaces may be formed by the first annular element and/or by the second annular element and/or by the third annular element.

In a most preferred embodiment, the sealing means are formed by sealing rings and/or by O-rings. Most preferably, a part of the sealing means is enclosed in the third annular element. This provides first of all for a compact solution, but also a solution where sealing means are able to be in the inner channel, such that the inner channel is lubricant tight when in connection with the pressure releasing element. Using annular elements with O-rings thus provides for an easy solution that allows for an inner channel to be adapted to the pressure releasing element. An alternative would be to hone the inner channel in the housing, but such a method is far more expensive and complex than manufacturing annular elements as described above. Thus, using annular element as here described provides for a low cost solution to form a lubricant tight inner channel.

### Transportable Lubrication System

In one embodiment of the transportable system, the first inlet of the pressure releasing coupling is connected to the pump, such that the lubricant is pumped to the lubrication target via the pressure releasing coupling.

In a second embodiment of the transportable system, the first outlet of the pressure releasing coupling is connected to the lubrication target, for example a machine part or a container. The connection may be via hoses adapted to guide lubricant.

In a preferred embodiment, the second outlet of the pressure releasing coupling is connected to the pump, such that liquid being guided out of the pressure releasing coupling via the second outlet is transferred back to the pump.

As described for the pressure releasing coupling, when the pressure is released by the pressure releasing element, lubricant is guided out of the coupling, such that the lubricant is not guided towards the target. However, by this embodiment, the lubricant as guided out when pressure is released, is guided back to the pump such that the lubricant is not spilled and via a detour, guided towards the target. Thus, this embodiment provides for a cost effective transportable lubrication system.

In most embodiments, the transportable system further comprises a housing, the housing comprising the pressure releasing coupling and/or the pump and/or a container adapted for holding the lubricant and/or a motor configured for driving the pump. In most embodiments, the housing comprises the pump and the motor. However, the container may be removeably attached to the transportable system.

In a preferred embodiment, the pump is a gear pump. A gear pump, in particular a reversible gear pump, is known to have a drainage, such as either an internal drainage or an external drainage or both. The internal drainage is typically for guiding leakage back into the suction hose internally. The inventors of the present disclosure have found that drainage(s) limit(s) the operating pressure of gear pumps. To provide a high pressure gear pump, the inventors have found that one solution is to modify existing gear pumps, such that the gear pump is configured for blocking drainage(s), such as an internal drainage and/or an external drainage, whereby the gear pump provides a pressure of more than 50 bars, such as more than 100 bars, such as more than 150 bars, such as more than 200 bars. A gear pump configured with no drain provides a more effective pump. Nevertheless, in some cases, since leakage cannot be guided anywhere, such a modified gear pump may destroy the drive shaft connection of the gear pump. In order to prevent such cases, the inventors have found that in some embodiments, the drive shaft-connection of the gear pump is enforced with a plate around the drive shaft, whereby the gear pump provides a for a gear pump that is able to withstand the pressure of more than 50 bars, such as more than 100 bars, such as more than 150 bars, such as more than 200 bars. Accordingly, the present disclosure provides an efficient high-pressure pump, in particular an efficient high-pressure gear pump.

In one embodiment, the gear pump has a weight less than 3 kg. This may contribute to the overall weight being less than a typical transportable lubrication station.

Also, in other embodiments, the gear pump is driven by motor having a weight less than 3 kg.

All in all, the transportable system as here described is in some embodiment found to have a weight less than 15 kg, such as less than 13 kg, such as less than 12 kg, such as less than 10 kg. A weight of this amount is able to be carried easily by a person. The word transportable may refer to transportable by a person, such as by carrying or rolling. In some embodiments, the word transportable may refer to a system that has a weight as just described.

### Example 1—an Embodiment of the Pressure Releasing Coupling According to the Present Disclosure in the First Position

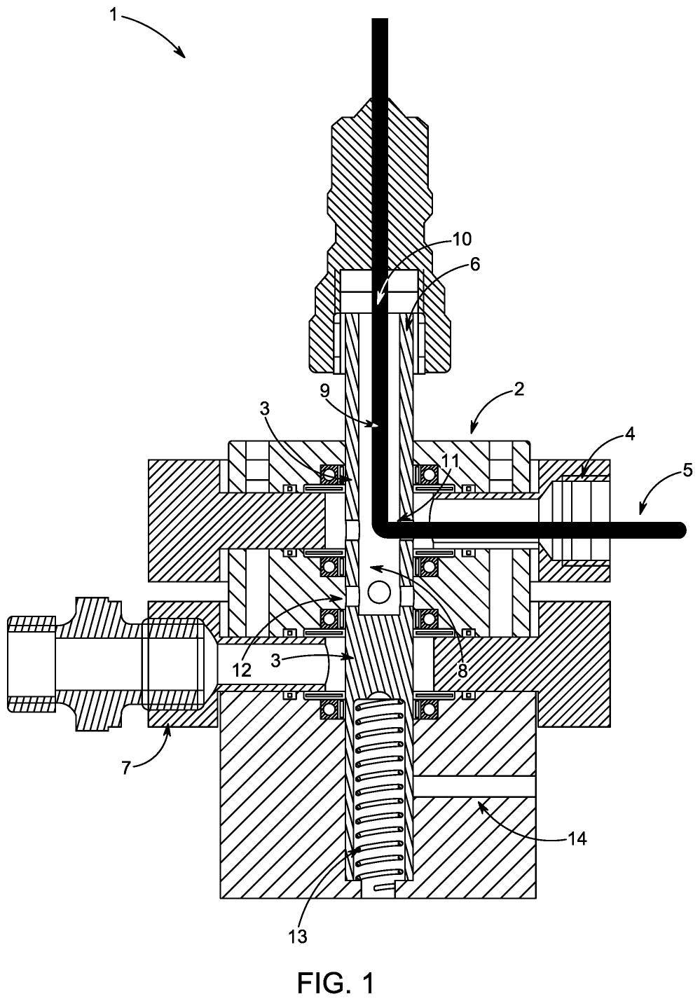

FIG. 1 shows pressure releasing coupling 1 according to the present disclosure. A housing 2 comprises an internal channel 3 inside the housing 2. FIG. 1 further shows a first inlet 4 for a receiving a lubricant 5 and a first outlet 6 for delivering the lubricant 5. Also is shown a second outlet 7 for delivering the lubricant 5. The first inlet 4, the first outlet 6 and the second outlet 7 are in fluid communication with the internal channel 3.

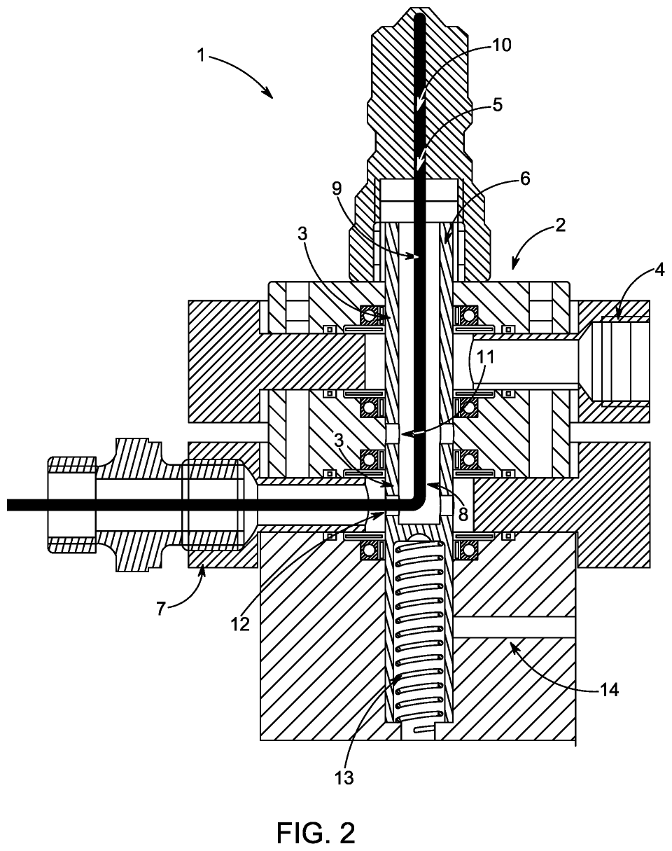

A pressure releasing element 8 is able to slide between a first position (as here shown) and a second position (as shown in FIG. 2) inside the internal channel 3. In the first position (as here shown), the lubricant 5 is guided from the first inlet 4 to the first outlet 6 and further to a lubrication target (not shown). At least a part of the pressure releasing element 8 comprises a hollow section 9 such that the lubricant 5 is guided within at least part of the hollow section 9 and inside the pressure releasing element 8. In this embodiment, the hollow section 9 is open-ended in one end 10 of the pressure releasing element 8, such that the first outlet 6 is formed by the pressure releasing element 8. The pressure releasing element 8 comprises in this example 8 side holes. FIG. 1 further shows a first side hole 11 and a second side hole 12. The pressure releasing element is thereby configured for guiding the lubricant into the hollow section 9 via the first side hole 11 and out of the hollow section 9 to the second outlet 7 via second side hole 12. Since the pressure releasing element is in the first position as shown, it can only be seen that the lubricant is guided into the hollow section 9 via the first side hole 11. Since in this embodiment, the first outlet 6 is formed by the pressure releasing element 8, and in the first position, the lubricant 5 is further guided from the hollow section to the first outlet 6. Part of the lubricant is in the first position (although not shown) guided from the hollow section and further to the second side hole 12. The housing 2 is configured such that when in the first position, the lubricant 5 is prevented from leaving the hollow section 9 via the second side hole 12. As can be seen from FIG. 1, the housing 2 is adapted with elements to tightly fit around the pressure releasing element 8 for blocking the second hole 12 in the first position. As shown, the pressure releasing 8 element is elongated and forms a male connector, i.e. it forms outer threads or outer connecting means. Both the first inlet 4 and the second outlet 7 form female connectors, i.e. both outlets have inner threads or inner connecting means. The housing 2 further comprises a push-back element 13, i.e. a spring 13, for being in contact with the pressure releasing element 8 such that when in the second position, the pressure releasing element 8 is forced back to the first position. The housing 2 further comprises a flush outlet 14 for guiding lubricant that is not guided out of the first outlet 6 and/or the second outlet 7. In case the housing 2 adapted with element does not properly fit around the pressure releasing element 8, for example, lubricant 5 may be guided out of the hollow section 9 of the pressure releasing element 8 and to the internal channel 3, passing the first outlet 6 and second outlet 7, ending in the bottom of the housing 2. The flush outlet 14 may then be used to flush the housing 2, such that no lubricant 5 is present in the housing 2. For example, the coupling 1 may be flushed with lubricant and/or a pressure that may exist in the coupling.

### Example 2—an Embodiment of the Pressure Releasing Coupling According to the Present Disclosure in the Second Position

FIG. 2 shows pressure releasing coupling 1 according to the present disclosure. A housing 2 comprises an internal channel 3 inside the housing 2. FIG. 2 further shows a first inlet 4 for a receiving a lubricant 5 and a first outlet 6 for delivering the lubricant 5. Also is shown a second outlet 7 for delivering the lubricant 5. The first inlet 4, the first outlet 6 and the second outlet 7 are in fluid communication with the internal channel 3.

A pressure releasing element 8 is able to slide between a first position (as shown in FIG. 1) and a second position (as here shown) inside the internal channel 3. In the second position, the lubricant 5 is guided from the first outlet 6 to the second outlet 7 for releasing the pressure in the first outlet 6. In the second position, the first inlet 4 is blocked by the pressure releasing element 8. The pressure in the first outlet may be a pressure from the pressure releasing coupling and all the way to a lubrication nibble. Thus, the pressure in the first outlet 6 may be the pressure in the hose connected to the first outlet 6. At least a part the pressure releasing element 8 comprises a hollow section 9 such that the lubricant 5 is guided within at least part of the hollow section 9 and inside the pressure releasing element 8. In this embodiment, the hollow section 9 is open-ended in one end 10 of the pressure releasing element 8, such that the first outlet 6 is formed by the pressure releasing element 8. The pressure releasing element 8 comprises in this example 8 side holes. FIG. 2 further shows a first side hole 11 and a second side hole 12. The pressure releasing element is thereby configured for guiding the lubricant into the hollow section 9 via the first side hole 11 and out of the hollow section 9 to the second outlet 7 via second side hole 12. Since the pressure releasing element is in the second position as shown, it can be seen that the lubricant is only guided out of the hollow section 9 to the second outlet 7 via the second side hole 12. Part of the lubricant 5 is in the second position (although not shown) guided from the hollow section and further to the first side hole 11. The housing 2 is configured such that when in the second position, the lubricant 5 is prevented from leaving the hollow section 9 via the first side hole 11. As can be seen from FIG. 2, the housing 2 is adapted with elements to tightly fit around the pressure releasing element 8 for blocking the first hole 12 in the second position. As shown, the pressure releasing 8 element is elongated and forms a male connector, i.e. it forms outer threads or outer connecting means. Both the first inlet 4 and the second outlet 7 form female connectors, i.e. both outlets have inner threads or inner connecting means. The housing 2 further comprises a push-back element 13, i.e. a spring 13, for being in contact with the pressure releasing element 8 such that when in the second position, the pressure releasing element 8 is forced back to the first position. The housing 2 further comprises a flush outlet 14 for guiding lubricant that is not guided out of the first outlet 6 and/or the second outlet 7. In case the housing 2 adapted with element does not properly fit around the pressure releasing element 8, lubricant 5 may be guided out of the hollow section 9 of the pressure releasing element 8 and to the internal channel 3, passing the first outlet 6 and second outlet 7, ending in the bottom of the housing 2. The flush outlet 14 may then be used to flush the housing 2, such that no lubricant 5 is present in the housing 2. For example, the coupling 1 may be flushed with lubricant and/or a pressure that may exist in the coupling.

### Example 3—an Embodiment of the Internal Channel of the Pressure Releasing Coupling According to the Present Disclosure

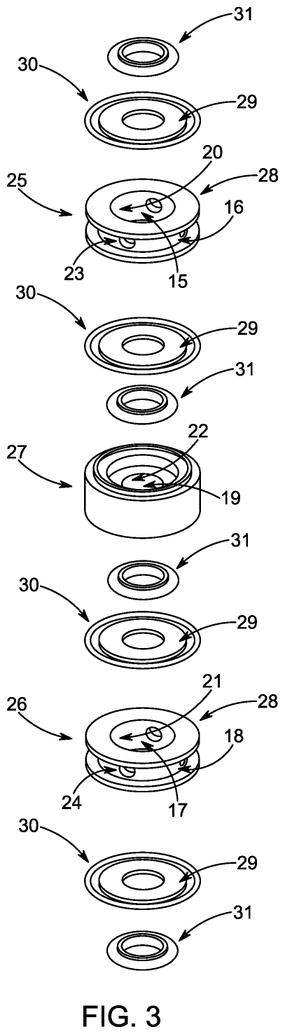

FIG. 3 shows an example of how a first inner channel 15 and a first outer channel 16 of the internal channel 3 (not shown) can be formed. It also shows how a second inner channel 17 and a second outer channel 18 of the internal channel 3 (not shown) can be formed. Finally, it also shows how a third inner channel 19 of the internal channel 3 (not shown) can be formed. The first inner channel 15, the second inner channel 17 and the third inner channel 19 have a first inner surface 20, a second inner surface 21 and third inner surface 22, respectively. The first outer channel 17 has four holes (one fully visible) forming a first plurality of holes 23, and the second outer channel 19 has another four holes forming the second plurality of holes 24.

According to the disclosure, there is an internal channel 3 inside the housing. The first inner channel 15, the second inner channel 17 and the third inner channel 19, are in this example formed by a first annular element, a second annular element, and a third annular element, respectively. All the inner channels, i.e. the first inner channel 15, the second inner channel 17 and the third inner channel 19 form a single inner connected channel.

The internal channel 3 further comprises a plurality of lubricant blocking surfaces such that the lubricant is further prevented from being guided between the first outer channel 16 and the second outer channel 18. The internal channel further 3 also comprises a plurality of sealing means such that the lubricant is further prevented from being guided between the first outer channel and the second outer channel. The first inner channel 15 and the second inner channel 17 are formed by a first annular element 25 and a second annular element 26 placed in the internal channel, each annular element 25, 26, comprising a cylindrical body with a plurality of holes 23, and wherein the first outer channel and the second outer channel each is formed by two flanges 28 extending radially from the cylindrical element. The third inner channel 19 is formed by a third annular element placed in the internal channel 3 between the first and the second annular element 27, the third annular element 27 comprising a cylindrical body. In this example, the lubricant blocking surfaces are formed by the first annular element 25, in particular by the flanges 28, the second annular element 26, in particular by the flanges 28, and the third annular element 27. Further blocking surfaces are annular discs 29 connected to the annular elements. The sealing means are formed by O-rings 30 and sealing rings 31. As can be seen from this example, the third annular element 27 is different from the two first annular elements 25, 26 in that it does not comprise any holes on the inner surface 22. On the other hand, the third annular element 27 is positioned in the internal channel, such that in the first position, the third annular element 27, in particular the inner surface 22, blocks the second side hole 12 of the pressure releasing element 8, and such that in the second position, the third annular element 27 blocks the first side hole 11 of the pressure releasing element 8. As can be understand from this example, the internal channel adapted to receive at least two annular elements. The internal channel is as described configured for forming a liquid-tight connection between two annular elements 25, 26. To form the liquid-tight connection between the two annular elements, the third annular element 27 is placed in-between the two annular elements 15. As also shown, an annular disc 29 and an O-ring 30 are placed on both the top and the bottom of the third annular element 27. A sealing ring 31 is placed in in-between the third annular element 18 and the annular disc 29. As shown, a set of an annular disc 29, an O-ring 30 and a sealing ring 21 is placed on all top and bottom surfaces of annular elements to provide the liquid-tight connection between each of them and in the bottom and top of the internal channel.

1. A pressure releasing coupling, comprising:
a housing comprising an internal channel inside the housing;
a first inlet for a receiving a lubricant;
a first outlet and a second outlet, each outlet for guiding the lubricant,
wherein the first inlet, the first outlet and the second outlet are in fluid communication with the internal channel; and
a pressure releasing element configured to slide between a first position and a second position inside the internal channel, and configured such that:
in the first position, the lubricant is guided from the first inlet to the first outlet, and
in the second position, the lubricant is guided from the first outlet to the second outlet for releasing a pressure in the first outlet.

2. The pressure releasing coupling according to claim 1, wherein at least a part of the pressure releasing element comprises a hollow section such that the lubricant is guided within at least part of the hollow section and inside the pressure releasing element.

3. The pressure releasing coupling according to claim 2, wherein the hollow section is open-ended in one end of the pressure releasing element, such that the first outlet is formed by the pressure releasing element.

4. The pressure releasing coupling according to claim 2, wherein the pressure releasing element comprises at least two side holes such that the pressure releasing element is configured for guiding the lubricant into the hollow section via at least a first side hole and out of the hollow section to the second outlet via at least a second side hole.

5. The pressure releasing coupling according to claim 2, wherein the pressure releasing element comprises more than two side holes, such as more than four side holes, such as more than six holes, such as eight holes, such that the pressure releasing element is configured for guiding the lubricant into the hollow section via at least two first side holes, such as via at least three first side holes, such as via four first side holes, and out of the hollow section to the second outlet via at least two second side holes, such as via at least three second side holes, such as via four second side holes.

6. The pressure releasing coupling according to claim 5, wherein the at least two first side holes each are dimensioned with a hole diameter being less than the diameter of the inlet, and such that a pressure in the inlet is identical to the pressure in the hollow section.

7. The pressure releasing coupling according to any of the preceding claims, wherein the pressure releasing element comprises the first outlet, such that movement of pressure releasing element from the first position to the second position moves the first outlet relative to the first inlet and the second outlet.

8. The pressure releasing coupling according to any of the preceding claims, wherein the pressure releasing element is elongated.

9. The pressure releasing coupling according to any of the preceding claims, wherein the first outlet forms a male connector.

10. The pressure releasing coupling according to any of the preceding claims, wherein the first inlet and/or the second outlet form(s) female connector(s).

11. The pressure releasing coupling according to any of the preceding claims, wherein the housing further comprises a push-back element configured such that when in the second position, the pressure releasing element is in contact with the push-back element, whereby the pressure releasing element is forced back to the first position.

12. The pressure releasing coupling according to claim 10, wherein the push-back element is a spring.

13. The pressure releasing coupling according to any of the preceding claims, wherein the internal channel further comprises a first inner surface that separates the internal channel into a first inner channel and a first outer channel,
wherein the first inner channel is adapted for tightly fitting around at least a first part of the pressure releasing element, and
wherein the first outer channel is adapted for guiding the lubricant from the first inlet into the pressure releasing element via a first plurality of holes in the first inner surface and further to the first outlet.

14. The pressure releasing coupling according to any of the preceding claims, wherein the internal channel further comprises a second inner surface that separates the internal channel into a second inner channel and a second outer channel,
wherein the second inner channel is adapted for tightly fitting around at least a second part of the pressure releasing element, and
wherein the second outer channel is adapted for guiding the lubricant out of the pressure releasing element via a second plurality of holes in the second inner surface and further to the second outlet.

15. The pressure releasing coupling according to claims 13 and 14, wherein the internal channel further comprises a third inner surface that narrows the internal channel into a third inner channel,
wherein the third inner channel is adapted for tightly fitting around at least a third part of the pressure releasing element, and adapted for blocking the lubricant from the pressure releasing element.

16. The pressure releasing element according to claim 15, wherein the internal channel further comprises a plurality of lubricant blocking surfaces such that the lubricant is further prevented from being guided between the first outer channel and the second outer channel.

17. The pressure releasing element according to any of the claims 15-16, wherein the internal channel further comprises a plurality of sealing means such that the lubricant is further prevented from being guided between the first outer channel and the second outer channel.

18. The pressure releasing coupling according to claims 13 and 14, wherein the first inner channel and the second inner channel are formed by a first annular element and a second annular element placed in the internal channel, each annular element comprising a cylindrical body with a plurality of holes, and wherein the first outer channel and the second outer channel each is formed by two flanges extending radially from the cylindrical element.

19. The pressure releasing coupling according to claim 18 wherein the third inner channel is formed by a third annular element placed in the internal channel between the first and the second annular element, the third annular element comprising a cylindrical body.

20. The pressure releasing coupling according to claim 16, wherein the lubricant blocking surfaces are formed the first annular element and/or the second annular element and/or the third annular element according to any of the claims 18-19.

21. The pressure releasing coupling according to claim 17, wherein the sealing means are formed by sealing rings and/or by O-rings.

22. The pressure releasing coupling according to any of the preceding claims, wherein the housing further comprises a flush outlet for guiding lubricant that is not guided out of the first and/or the second outlet.

23. The pressure releasing coupling according to any of the preceding claims, wherein the first inlet is parallel to the second outlet and the first outlet is perpendicular to the first inlet.

24. A transportable system for delivering lubricant to a lubrication target, comprising:
a pump connected to the pressure releasing coupling according to any of the claims 1-23; and/or.
a gear pump; and/or
a pump configured for delivering lubricant at a flow rate of more than 1 kg per minute.

25. The transportable system according to claim 24, wherein the first inlet of the pressure releasing coupling is connected to the pump, such that the lubricant is pumped to the lubrication target via the pressure releasing coupling.

26. The transportable system according to any of the claims 24-25, wherein the first outlet of the pressure releasing coupling is connected to the lubrication target.

27. The transportable system according to any of the claims 24-26, wherein the second outlet of the pressure releasing coupling is connected to the pump, such that liquid being guided out of the pressure releasing coupling via the second outlet is transferred back to the pump.

28. The transportable system according to any of the claims 24-27, wherein the transportable system further comprises a housing, the housing comprising the pressure releasing coupling and/or the pump and/or a container adapted for holding the lubricant and/or a motor configured for driving the pump.

29. The transportable system according to any of the claims 24-28, wherein the pump is a gear pump.

30. The transportable system according to claim 27, wherein the gear pump is configured for blocking drainage(s), such as an internal drainage and/or an external drainage, whereby the gear pump provides a pressure of more than 50 bars, such as more than 100 bars, such as more than 150 bars, such as more than 200 bars.

31. The transportable system according to claim 28, wherein a drive shaft-connection of the gear pump is enforced with a plate around the drive shaft, whereby the gear pump provides a for a gear pump that is able to withstand the pressure of more than 50 bars, such as more than 100 bars, such as more than 150 bars, such as more than 200 bars.

32. The transportable system according to any of the claims 29-31, wherein the gear pump has a weight less than 3 kg.

33. The transportable system according to any of the claims 29-31, wherein the gear pump is driven by motor having a weight less than 3 kg.

34. The transportable system according to any of the claims 29-31, wherein the transportable system has a weight less than 15 kg, such as less than 13 kg, such as less than 12 kg, such as less than 10 kg.

35. Use of the transportable system according to any of the claims 24-34 for lubricating machine parts, such as in a wind turbine.

36. Use of the transportable system according to any of the claims 24-34 for re-filling lubricant in a central lubrication system, such as used in a single wind turbine.

37. Use of the transportable system according to any of the claims 24-34 for re-filling lubricant in a de-central lubrication system, such as used in a wind turbine park.
